(19) United States
(12) Patent Application Publication
(10) Pub. No.: US 2012/0271821 A1
(43) Pub. Date: Oct. 25, 2012

(54) Noise Tolerant Graphical Ranking Model

(75) Inventors: Tao Qin, Beijing (CN); Tie-Yan Liu, Beijing (CN); Xiubo Geng, Beijing (CN)

(73) Assignee: Microsoft Corporation, Redmond, WA (US)

(21) Appl. No.: 13/090,848

(22) Filed: Apr. 20, 2011

(51) Int. Cl. G06F 17/30

(52) U.S. Cl. 707/728; 707/E17.08; 707/E17.079

(57) ABSTRACT

The relevance of an object, such as a document resulting from a query, may be determined automatically. A graphical model-based technique is applied to determine the relevance of the object. The graphical model may represent relationships between actual and observed labels for the object, based on features of the object. The graphical model may take into account an assumption of noisy training data by modeling the noise.

### BACKGROUND

Recent years have witnessed an explosive growth of data available on the Internet. As the amount of data has grown, so has the need to be able to locate relevant data and rank the data according to its relevance. Ranking is a key issue in many applications, such as information retrieval applications which retrieve data, such as documents, in response to a query. Ranking can provide an indication of whether retrieved documents may be relevant to the query or include information sought for in the query.

One approach to determining the relevance of data and ranking the data is to use machine learning techniques. Machine learning techniques may use sets of training data to learn relevance and ranking functions. A common assumption, however, is that the relevance labels of training data (e.g., training documents) are reliable. In many cases, this is not so. For example, when multiple human annotators are tasked to label the same document for its relevance to a query, there are often annotators who disagree with the majority. This indicates a likelihood that training data that is annotated by a single annotator (which is common in practice) will contain noise (i.e. some discrepancy as compared with a majority of multiple annotators).

This is understandable when considering the generally short and ambiguous nature of most queries, and the amount of information in documents (e.g., web pages, etc.), relative to different aspects of a query. Without knowing the intent of a query, for example, it can be difficult to know which aspects of the query are the most important. Further, relevance judgments can be more subjective than objective, since they are often dependent on the annotator's own perspective.

Using traditional learning techniques with noisy training data may create low quality ranking models.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The term “techniques,” for instance, may refer to device(s), system(s), method(s) and/or computer-readable instructions throughout the document.

In one aspect, the application describes automatically determining a relevance of an object, such as for example, a document, to a query, using a graphical model. In some embodiments, the graphical model shows relationships between an observed label for the object, the actual (i.e., true) label for the object, features of the object, and weights of the features. The relationships may be modeled using one or more observed and/or hidden modeling parameters.

The determining may include receiving a set of training data for a machine learning technique that may contain noise. At least one modeling parameter for the graphical model is learned by maximizing a log likelihood of the training data. Noise in the training data and a ranking function are modeled using the graphical model, based on the at least one modeling parameter. The relevance of the document may be determined using input from the graphical model, and outputted. In one embodiment, an output includes relevance data arranged by rank.

In alternate embodiments, iterative techniques such as regression may be employed to learn one or more modeling parameters.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram of an example system that determines the relevance of an object, including example system components.

FIG. 2 is a block diagram of an example graphical model. The graphical model shows relationships between an actual label, an observed label, an object feature, and a weight parameter of the object feature, according to an example embodiment.

FIG. 3 is a flow diagram illustrating an example process by which the relevance of an object may be determined.

### DETAILED DESCRIPTION

Various techniques for determining the relevance of an object using a noise tolerant ranking model are disclosed. For ease of discussion, the disclosure describes the various techniques with respect to a document, for example, a document resulting from a query. However, the descriptions also may be applicable to determining the relevance to a query or other input of other objects such as a video, an audio file, another media file, a data file, a text file, and the like.

In one embodiment, techniques are employed to automatically determine the relevance of a document (i.e., a web page, a text document, etc.) to a query, for example, a search engine query. For example, a user may initiate a web-search based on the query “machine learning.” In this case, the techniques discussed herein determine the relevance of documents that are returned by the search engine in response to the query. Various web sites, web pages, portable documents, media files, data files, and the like may be returned, with the relevance determined for each returned object. Additionally, in some embodiments, the returned documents may be returned in the order of their ranked relevance. In alternate embodiments, techniques may be employed to present other outputs (e.g., a database of the results, one or more annotated tables, customized reports, etc.) to a user.

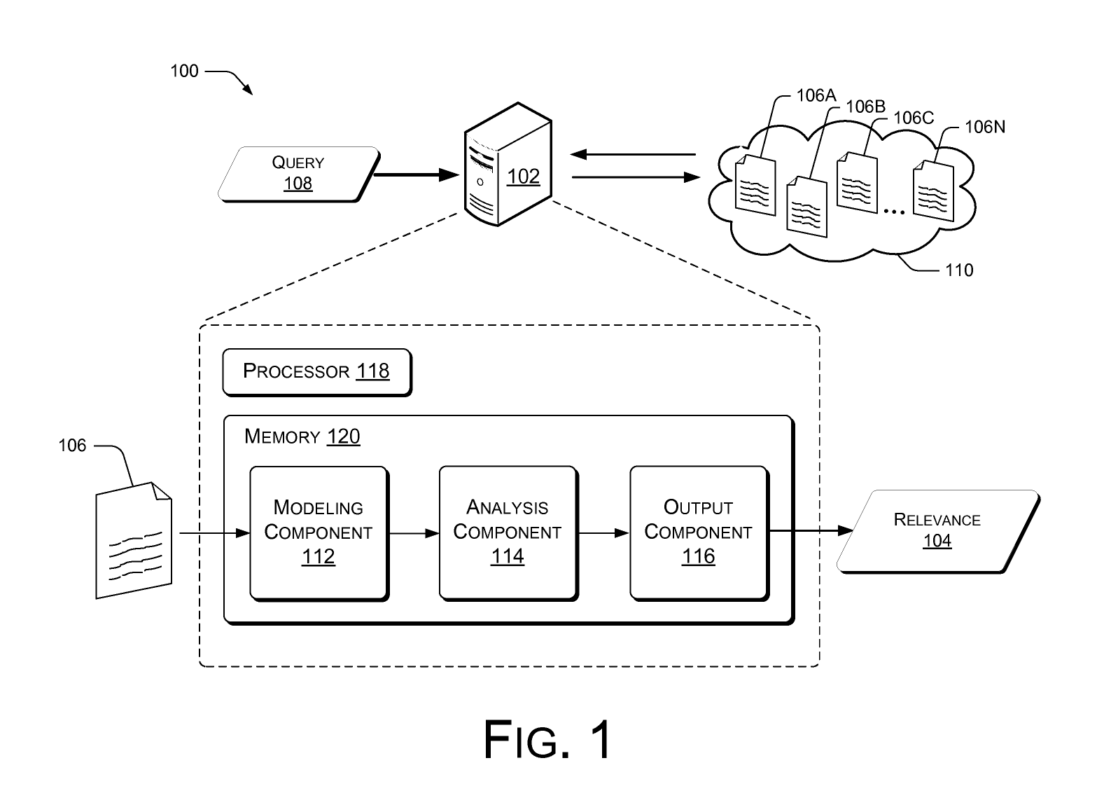

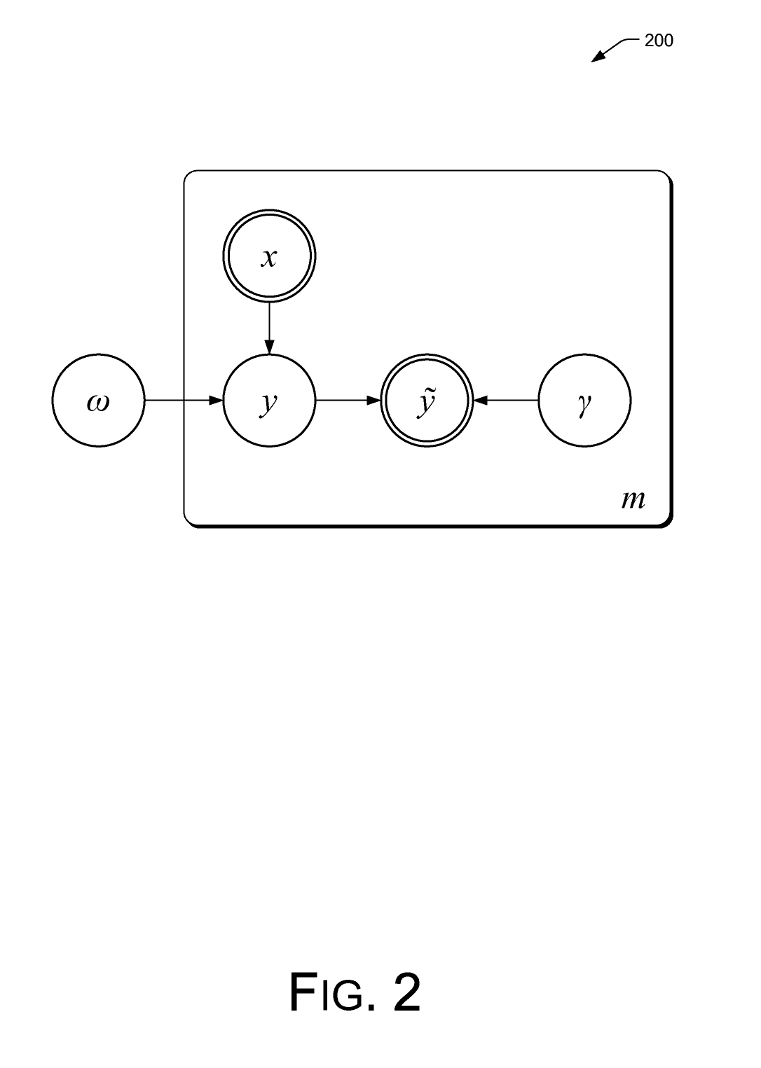

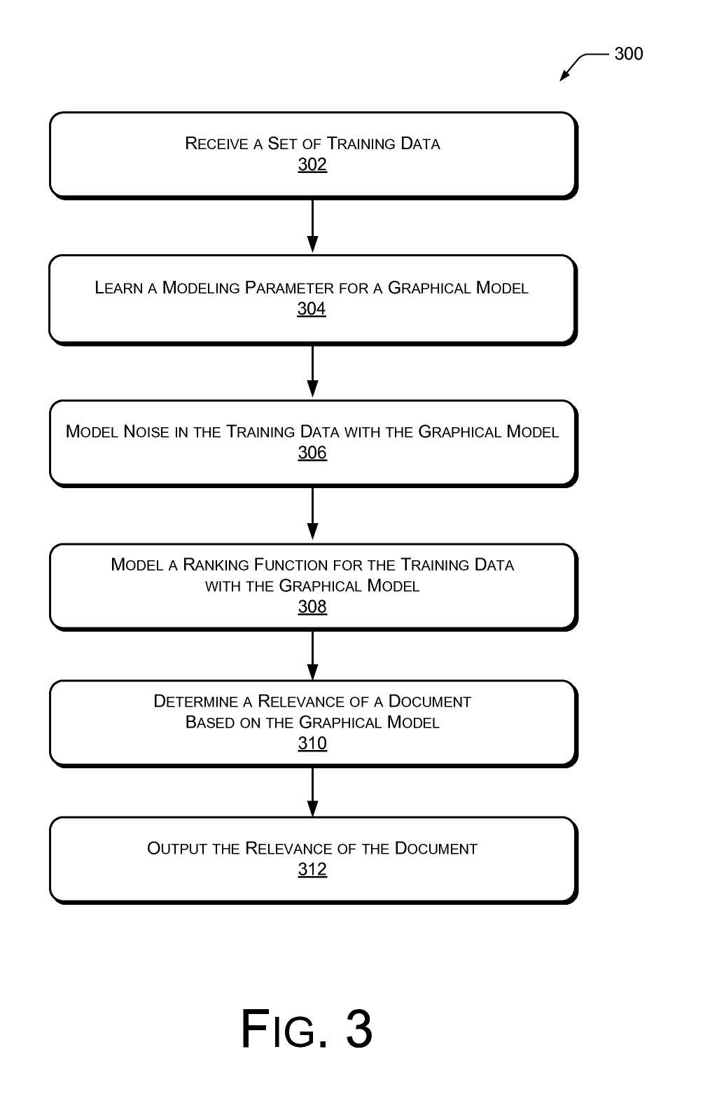

Various techniques for determining a relevance of an object are disclosed. The discussion herein includes several sections. Each section is intended to be non-limiting. More particularly, this entire description is intended to illustrate components which may be utilized in determining the relevance of an object, but not components which are necessarily required. An overview of a system or technique for determining a relevance of an object is given with reference to FIGS. 1 and 2. Included are discussions of an example system that may be employed, a noise tolerant graphical ranking model that may be used (as shown in FIG. 2), and an example algorithm that may be used. Example methods for determining a relevance of an object are then discussed with reference to FIG. 3.

### Overview

In general, techniques are disclosed for determining the relevance of an object, based on learning to rank from (assumed) noisy data, using a noise tolerant probabilistic graphical model. In one embodiment, the noise tolerant graphical model is a probabilistic model. The use of a probabilistic graphical model may benefit from advantages, including:
(1) It distinguishes the actual (i.e., true) relevance label of each object from its observed label. This enables modeling the ranking function (the relationship between actual labels of objects and their features) and modeling the generation of noise (the relationship between actual labels of objects and their observed labels) separately.
(2) A conditional random field (CRF) model may be used to formulate a conditional dependency of the actual labels of objects on their features, capturing the orders (i.e., ranking) of documents, and not just relevance labels themselves.
(3) The probabilistic graphical model is flexible, in that it is tolerant of different noise levels for different queries. This is compatible with the tendency for noise to occur in judging queries, as discussed above.

FIG. 1 is a block diagram of an example arrangement 100 that is configured to determine the relevance of an object. In the example, a system 102 uses graphical modeling techniques to determine the relevance 104 of an object 106, for instance, to a query 108. In the illustration, example inputs to the system 102 include a query 108 (submitted by a user, for example) and one or more objects 106 (for example, 106A, 106B, 106C . . . 106N) resulting from the query 108. A single object 106, or a plurality of objects 106 (for example, 106A, 106B, 106C . . . 106N), may be input to the system 102. In alternate embodiments, the objects 106 may be obtained from various storage locations, such as the Internet, an intranet, a remote server, a local data source, and the like. Example outputs of the system 102 include the relevance 104 of the object 106 to the query 108. In alternate embodiments, fewer or additional inputs may be included. Examples of additional inputs include feedback, constraints, etc. Additionally or alternately, other outputs may also be included, such as a ranking arrangement.

In one embodiment, the system 102 may be connected to a network 110, and may receive the objects 106 from locations on the network 110. In the example of FIG. 1, objects 106A-106N are shown as results of query 108. In alternate embodiments, the system 102 may receive fewer or greater numbers of objects 106, including hundreds or thousands of objects 106. The number of objects 106 found by a search engine, for example, and input to the system 102 may be based on documents, images, media files, and the like, relating to the query, that have been posted to the Internet, for example. In alternate embodiments, the network 110 may include a network (e.g., wired or wireless network) such as a system area network or other type of network, and can include several nodes or hosts, (not shown), which can be personal computers, servers or other types of computers. Other examples of the network include: an Ethernet LAN, a token ring LAN, or other LAN, a Wide Area Network (WAN), and others. Moreover, such network can also include hardwired and/or optical and/or wireless connection paths. For instance, the network 110 may represent a wealth of varied continent and connectivity, such as seen in the Internet, various intranets, etc. In an example embodiment, the network 110 includes an intranet or the Internet.

### Example System for Determining Relevance

Example systems for determining the relevance 104 of an object 106, for example, to a query 108 are discussed with reference to FIGS. 1 and 2. In one embodiment, as illustrated in FIG. 1, the system 102 is comprised of a modeling component 112, an analysis component 114 and an output component 116. The example system 102 also includes a processor 118 and memory 120. In alternate embodiments, the system 102 may be comprised of fewer or additional components, within which differently arranged structures may perform the techniques discussed within the disclosure.

All or portions of the subject matter of this disclosure, including the modeling component 112, the analysis component 114 and/or the output component 116 (as well as other components, if present) can be implemented as a system, method, apparatus, or article of manufacture using standard programming and/or engineering techniques to produce software, firmware, hardware or any combination thereof to control a computer or processor to implement the disclosure. For example, an example system 102 may be implemented using any form of computer-readable media (shown as memory 120 in FIG. 1, for example) that is accessible by the processor 118. Computer-readable media may include, for example, computer storage media and communications media.

Computer-readable storage media includes volatile and nonvolatile, removable and non-removable media implemented in any method or technology for storage of information such as computer-readable instructions, data structures, program modules or other data. Memory 120 is an example of computer-readable storage media. Additional types of computer-readable storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by the processor 118.

In contrast, communication media typically embodies computer readable instructions, data structures, program modules, or other data in a modulated data signal, such as a carrier wave, or other transport mechanism.

While the subject matter has been described above in the general context of computer-executable instructions of a computer program that runs on a computer and/or computers, those skilled in the art will recognize that the subject matter also may be implemented in combination with other program modules. Generally, program modules include routines, programs, components, data structures, and the like, which perform particular tasks and/or implement particular abstract data types.

Moreover, those skilled in the art will appreciate that the innovative techniques can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the disclosure can be practiced on stand-alone computers. In a distributed computing environment, program modules may be located in both local and remote memory storage devices.

In one example embodiment, as illustrated in FIG. 1, the system 102 receives an object 106 as a result of a query 108 and determines the relevance 104 of the object 106 to the query 108. If included, the modeling component 112 enables the system 102 to learn relevance ranking (i.e., annotate or “label” an object indicating its relevance, for example, to a query) with training data that may be noisy. For example, the modeling component 112 may enable the system 102 to more accurately rank objects 106 with respect to queries 108 using noisy training data. In one embodiment, the modeling component 112 models the noise in the training data as well as the ranking function using a graphical model (for example, graphical model 200 as shown in FIG. 2). For example, the modeling component 112 may be configured to model noise in training data with a graphical model, where the graphical model represents a relationship between an actual relevance label and an observed relevance label of the object. In an implementation, the modeling component models the noise by including or more modeling parameters representing the noise in the graphical model 200. In one example, the modeling component 112 refines the graphical model 200 based in part on noise in the training data. Additionally or alternatively, the modeling component 112 may be configured to model a ranking function, where the graphical model represents a relationship between the actual label and one or more features of the object. In one example, the modeling component 112 adjusts the graphical model 200 based in part on the ranking function. Example ranking functions are described further below.

If included, the analysis component 114 (as shown in FIG. 1) may determine the relevance of the object 106 based on the graphical model of the modeling component 112. For example, the modeling component 112 may be configured to model the ranking function by mapping each of one or more features of the object 106 to a score representing a level of relevance using a weight parameter of the one or more features. For example, in one embodiment, the greater the score, the more likely the relevance of the object 106 to the query 108. The analysis component 114 may be configured to determine whether the score is consistent with the actual relevance label of the object, once the actual relevance label has been determined. In one embodiment, the analysis component 114 is configured to measure the consistency of the score to the actual label based on a pairwise comparison of the object to another object. For example, if the object has a higher score than the other object, then the object should also be more relevant (and have a label indicating greater relevancy) to the query 108 than the other object.

In an implementation, the analysis component 114 is configured to associate the object 106 with at least two random variables to determine the relevance of the object 106: a hidden variable representing the actual label and an observable variable representing the observed label. In an example, the hidden and observable variables are modeling parameters of the graphical model 200. The hidden and observable parameters in these and other examples are discussed further in a later section.

If included, the output component 116 (as shown in FIG. 1) may provide an output from the system 102. For example, an output may be provided from the system 102 to another system or process, and the like. In an embodiment, the output may include the relevance 104 of the object 106 in response to a query 108. In an alternate embodiment, the output may also include information (or annotations) regarding the relevance or ranking of the object 106 (e.g., features considered, feature weights, etc.).

In various embodiments, the relevance 104 of the object 106 may be indicated by a prioritized or ranked list. In one example of the prioritized or ranked list, the output component 116 may output the relevance 104 of an object (for example 106A) with respect to another object (for example 106B) and output the relevance 104 of the objects in an arrangement according to their respective rankings. This provides an indication of the relative relevance of 106A and 106B. In other examples, the prioritized or ranked list may contain any number of objects and their relative relevance to a query 108. Additionally or alternatively, the relevance 104 of the object 106 may be presented in the form of a general or detailed analysis, and the like.

In one embodiment, the output of the system 102 is displayed on a display device (not shown). In alternate embodiments, the display device may be any device for displaying information to a user (e.g., computer monitor, mobile communications device, personal digital assistant (PDA), electronic pad or tablet computing device, projection device, imaging device, and the like). For example, the relevance 104 may be displayed on a user's mobile telephone display (in the case of a query performed from a mobile browser, for example). In alternate embodiments, the output may be provided to the user by another method (e.g., email, posting to a website, posting on a social network page, text message, etc.).

### Example Graphical Model

An example graphical model 200 is shown in the illustration of FIG. 2. The elements of the graphical model 200 are for illustration and ease of discussion. In alternate examples, a graphical model 200 may contain fewer or additional elements, yet would remain within the scope of the disclosure. In various embodiments, the graphical model 200 is a graphical noise-tolerant probabilistic ranking model. Some of the elements of the graphical model 200 may be observable (as indicated by double outlined circles) and some of the elements of the graphical model 200 may be hidden or initially hidden (as indicated by single outlined circles). A hidden element, for example, is one that is not readily observable or apparent. However, a hidden element may be discovered through a process, as discussed further, based on observable elements and properties of an object.

In one example embodiment, the graphical model 200 may be comprised of parameters (e.g., variables, vectors, quantities, etc.), rules (e.g., equations, conditions, constraints, etc.), relationships, probabilities, and the like, arranged to assist in determining a relevance of an object 106 to a query 108. In various embodiments, this may include determining the actual relevance label of the object 106.

Example elements of the graphical model 200 include the actual label y, which represents the actual relevance label of the object 106. The actual label y is initially hidden since it is not readily observable or apparent, but it may be determined by the techniques described. The observed label of the object 106 is represented by \tilde{y}. The observed label \tilde{y} is a label that has been annotated to the object 106. In an embodiment, the observed label \tilde{y} is an initially proposed relevance label for the object 106, indicating the object's relevance to a query 108. For the purposes of the graphic model 200, it may be assumed that the observed label \tilde{y} is noisy.

As shown in FIG. 2, γ represents the noise, or the degree of noise, associated with the observed label \tilde{y}. For the purposes of this disclosure, noise γ is intended to represent an amount or degree of discrepancy in an assignment or annotation of a label to an object (for example, by a single annotator as compared to a majority of multiple annotators). Noise γ includes any statistically probable disagreement inherent in an observed label, between the observed label and an actual (i.e., true) label. The noise parameter γ is initially hidden (as shown by the single outlined circle), since the degree of noise in the observed label \tilde{y} may be initially unknown. When an object 106 with an observed label \tilde{y} is included in training data, then γ represents noise in the training data, as included in the graphical model 200.

Other example elements of the graphical model 200 include the parameter x, which represents one or more observable features of the object 106 (i.e., object features). In various embodiments, the parameter x is flexible, meaning that it may not be dependent on specific features of the object 106. In an embodiment, the parameter x represents aspects of the object 106 that determine its relevance. For example, in some embodiments, x is a feature vector representing observable relevancy features of the object 106, such as, the number of times the object 106 has been accessed in a specified time frame (e.g., access of a web page, etc.), the number of times a term or component (such as a word or phrase, for example) is found in an object 106, the frequency that the object 106 is updated (e.g., updates to a web page, etc.), and the like.

As shown in FIG. 2, ω represents the weight of a feature x. For example, the parameter ω may indicate which of a number of observable features x may be given more weight, or the extent that one or more features x are instrumental in determining the actual label y of an object 106. The weight parameter ω may not be initially apparent, so it is shown as a hidden element in the illustration of FIG. 2.

In one embodiment, the graphical model 200 describes a joint probability distribution of the actual label y and the observed label \tilde{y}, given one or more features x of the object 106. The joint probability distribution may include a conditional probability of the actual label y given the one or more features x of the object 106, and considering the weight parameter ω of the one or more features x. The conditional probability may be described using equations shown in a later section.

The graphical model 200 may be applied as part of an example technique to learn ranking with noisy training data. For example, techniques may be used with reference to a query q (not shown). In an embodiment, n_{q} denotes the number of documents associated with query q, d denotes the number of document features, and k denotes the number of possible relevance labels. Additionally, (x^{q}, \tilde{y}^{q}) may be used to denote the data associated with query q in a training set, where x^{q} is an n_{q}×d matrix with the i-th row x^{q}ᵢ representing the feature vector of the i-th object 106, and \tilde{y}^{q}∈{0, 1, . . . , k−1}ⁿ^{_{q}} is a n_{q}-dimensional vector with the i-th element \tilde{y}ᵢ^{q} representing the observed (noisy) label of the i-th object (e.g., an object 106 as seen in FIG. 1). In one embodiment, the larger the value of the observed label \tilde{y}, the more relevant the object 106 is to the query. For example, 0 may correspond to the least relevant, and k−1 may correspond to the most relevant. In a further embodiment, the training set can be represented as S={(x^{q}, \tilde{y}^{q})}_{q=1}^{m}, where m (as shown in FIG. 2) is the number of training queries.

As discussed above, it may be assumed that labels assigned to or annotated to objects 106 contain noise. Accordingly, the hidden element y^{q}∈{0, 1, . . . , k−1}ⁿ^{_{q}} may represent the actual (i.e., true) label for the object 106, with the i-th element yᵢ^{q} representing the true label of the i-th object 106. The graphical model 200, as shown in FIG. 2, may represent the relationship between the features x of the objects, their observed labels \tilde{y}, and their true labels y. In one embodiment, the graphical model 200 describes the joint probability distribution of the true labels y and the observed labels \tilde{y} given the object features: P(y^{q}, \tilde{y}^{q}|x^{q}). In an implementation, \tilde{y}^{q} is conditionally independent of x^{q} given y^{q}, so the joint probability may be decomposed into two parts (two conditional probabilities):
A. P(y^{q}|x^{q}; ω), representing the conditional probability of the actual labels y given the document features x, where ω is the parameter for all queries q; and
B. P(\tilde{y}^{q}|y^{q}; γ^{q}), representing the conditional probability of the observed labels \tilde{y} given the actual labels y, where γ^{q} is a query-dependent parameter.

The aforementioned decomposition can be written:

P(y^{q},\tilde{y}^{q}|x^{q};ω,γ^{q})=P(y^{q}|x^{q};ω)P(\tilde{y}^{q}|y^{q};γ^{q}). Eqn. (1)

Then, the likelihood of the training data S={(x^{q},\tilde{y}^{q})}_{q=1}^{m} may be written:

$$\begin{matrix}L ( ω , γ ) = {\prod }_{q} P ( {\tilde{y}}^{q} \vert {x}^{q} ; ω , {γ}^{q} ) \\ = {\prod }_{q} {\sum }_{{y}^{q}} P ( {y}^{q} \vert {x}^{q} ; ω ) P ( {\tilde{y}}^{q} \vert {x}^{q} ; ω , {γ}^{q} ) .\end{matrix} \qquad Eqn . ( 2 )$$

where L (ω,γ) represents the log likelihood of the parameters ω and γ.

The two conditional probabilities (A and B) as incorporated into equation (2) are defined in the following subsections. For ease of the remainder of the discussion, the superscript q is implied on the terms (as shown above), but may not be written.

Conditional Probability A: P(y|x;ω)

In one embodiment, the first conditional probability P(y|x;ω) is defined using a conditional random field (CRF) according to the equation:

$$P ( y \vert x ; ω ) = \frac{exp \{ {\sum }_{i} {\sum }_{j} {ω}^{T} ( {x}_{i} - {x}_{j} ) I ( {y}_{i} > {y}_{j} ) \}}{Z ( x )} , \qquad Eqn . ( 3 )$$

where I(•) is the indicator function, and

Z(x)=Σ_{y}exp{ΣᵢΣⱼω^{T}(xᵢ−xⱼ)I(yᵢ>yⱼ)}.

Each object feature xᵢ is mapped to a score using the parameter ω, and then the scores of the objects 106 are checked for consistency with their actual relevance labels. For example, the consistency may be measured by checking every pair of objects 106 with yᵢ>yⱼ (where yᵢ is an actual relevancy label of an i-th object and yᵢ is an actual relevancy label of a j-th object) to determine whether the score of the first object 106 is larger than that of the second one. The larger the difference implies a higher probability P(y|x).

Thus, by using the above formulation, the feature functions in the CRF are defined as pairwise comparisons between two different objects 106.

Conditional Probability B: P(\tilde{y}|y;γ)

In an embodiment, the second probability P(\tilde{y}|y;γ) is defined based on a multinomial noise model. First, given the actual label y, the noisy label \tilde{y} is assumed to be independent of the object features x, but not independent of the query q. The noisy label \tilde{y} is dependent on the query q because it depends on the parameter γ, which is query specific. In this way, the graphical model 200 can reflect that some queries may be more likely to be judged (i.e., annotated, labeled, etc.) mistakenly, as discussed above. The probability may be first defined as:

P(\tilde{y}|y;γ)=ΠᵢP(\tilde{y}ᵢ|yᵢ;γ) Eqn. (4)

Second, for a query q, it is assumed that the objects 106 that result are correctly labeled with a probability 1−γ and incorrectly labeled with a probability γ, with each of the k−1 incorrect labels being equally likely. Then, P(\tilde{y}ᵢ|yᵢ;γ) can be represented as:

$$P ( {\tilde{y}}_{i} \vert {y}_{i} ; γ ) = {( 1 - γ )}^{I ( {y}_{i} = {\tilde{y}}_{i} )} {( \frac{γ}{k - 1} )}^{I ( {y}_{i} \neq {\tilde{y}}_{i} )} \qquad Eqn . ( 5 )$$

Combining equations (4) and (5) results in the equation:

$$P ( \tilde{y} \vert y ; γ ) = {\prod }_{i} {( 1 - γ )}^{I ( {y}_{i} = {\tilde{y}}_{i} )} {( \frac{γ}{k - 1} )}^{I ( {y}_{i} \neq {\tilde{y}}_{i} )} . \qquad Eqn . ( 6 )$$

As is shown above, in the described embodiment, a query-dependent multinomial distribution (i.e., the parameters γ are different for different queries), may be used herein to define the second conditional probability.

### Example Learning Algorithm

In various embodiments, a learning algorithm is used to learn and infer elements of the graphical model 200. Given a set of training data S={(x^{q}, \tilde{y}^{q})}_{q=1}^{m}, the parameters ω and γ of the graphical model 200 can be learned by maximum likelihood estimation. Then, the parameter ω can be used to rank the objects 106 for a query q.

In one embodiment, one or more of the model parameters ω and γ of the graphical model 200 may be learned by maximizing a log likelihood (see equation (2)) of the training data. An example learning algorithm may be expressed as:

$$\begin{matrix}( {ω}^{*} , {γ}^{*} ) = {argmax}_{( ω , γ )} log L ( ω , γ ) \\ = {argmax}_{( ω , γ )} {\sum }_{q} log {\sum }_{{y}^{q}} \\ \{ P ( {y}^{q} \vert {x}^{q} ; ω ) P ( {\tilde{y}}^{q} \vert {y}^{q} ; {γ}^{q} ) \} .\end{matrix} \qquad Eqn . ( 7 )$$

In one embodiment, maximizing a log likelihood of the set of training data includes iterating an expectation maximization (EM) technique on the set of training data until the iterations converge. In one implementation, the EM technique iterates between an E (expectation) step and an M (maximization) step. For example, the maximizing may include iteratively performing operations of: estimating an expected value of the log likelihood of the training data, with respect to the probability of the relevance of the document, given feature vectors of the document, a proposed relevance of the document, and an estimate of the modeling parameter (E step); and selecting a modeling parameter that maximizes the expected value of the log likelihood (M step).

In one implementation, the E step includes estimating the expected value of the log-likelihood of the complete data, log P(y^{q}, \tilde{y}^{q}|x^{q};ω,γ^{q}), with respect to the probability of the hidden variable y^{q}, given the observation (y^{q},x^{q}) and the current parameter estimates (ω^{t}, γ^{q,t}) (estimated in the t-th iteration). When the expectation function is denoted as T(ω, γ|ω^{t}, γ^{t}), then the expected log-likelihood expression may be written as:

T(ω,γ|ω^{t},γ^{t})=Σ_{q}Σ_{y}_{^{q}} log P(y^{q},\tilde{y}^{q}|x^{q};ω,γ^{q})P(y^{q}|\tilde{y}^{q},x^{q};ω^{t},γ^{q,t}). Eqn. (8)

Substituting equation (2) into equation (8) results in:

T(ω,γ|ω^{t},γ^{t})=T₁(ω)+T₂(γ), Eqn. (9)

where:

$$\begin{matrix}{T}_{1} ( ω ) = {\sum }_{q} {\sum }_{{y}^{q}} {ω}^{T} f ( {x}^{q} , {y}^{q} ) - p ( {y}^{q} ) {\sum }_{q} log Z ( {x}^{q} ) , and & Eqn . ( 10 ) \\ {T}_{2} ( γ ) = y {\sum }_{q} {\sum }_{{y}^{q}} {\sum }_{i} \{ \begin{matrix}I ( {y}_{i}^{q} = {\tilde{y}}_{i}^{q} ) log ( 1 - {γ}^{q} ) + \\ {\sum }_{i} I ( {y}_{i}^{q} \neq {\tilde{y}}_{i}^{q} ) ( log ( {γ}^{q} ) - log ( k - 1 ) )\end{matrix} \} p ( {y}^{q} ) , & Eqn . ( 11 ) \\ \begin{matrix} p ( {y}^{q} ) = P ( {y}^{q} \vert {\tilde{y}}^{q} , {x}^{q} ; {ω}^{t} , {γ}^{q , t} ) \\ = \frac{exp \{ {ω}^{{t}^{T}} f ( {x}^{q} , {y}^{q} ) \} g ( {y}^{q} , {γ}^{q , t} )}{{\sum }_{{y}^{q}} exp \{ {ω}^{{t}^{T}} f ( {x}^{q} , {y}^{q} ) \} g ( {y}^{q} , {γ}^{q , t} )} ,\end{matrix} & Eqn . ( 12 ) \\ f ( {x}^{q} , {y}^{q} ) = {\sum }_{i} {\sum }_{j} ( {x}_{i}^{q} - {x}_{j}^{q} ) I ( {y}_{i}^{q} > {y}_{j}^{q} ) , & Eqn . ( 13 ) \\ g ( {y}^{q} , {γ}^{q , t} ) = {( 1 - {γ}^{q , t} )}^{{\sum }_{i} 1 ( {y}_{i}^{q} = {\tilde{y}}_{i}^{q} )} {( \frac{{γ}^{q , t}}{k - 1} )}^{{\sum }_{i} I ( {y}_{i}^{q} \neq {\tilde{y}}_{i}^{q} )} . & Eqn . ( 14 )\end{matrix}$$

In an embodiment, the entire y^{q} space is summed in equations (10), (11), and (12), which consist of 2ⁿ^{_{q}} elements. To reduce complexity, the observed label \tilde{y}^{q} may be taken as a starting point, and the labels of at most two objects 106 are flipped to get a new sample each time. Using this strategy in an alternate embodiment, O(n_{q}²) samples are summed for query q, which results in improved efficiency over using the full samples.

In one implementation, the E step includes choosing parameters that maximize the expectation computed in the E step:

(ω^{t+1},γ^{t+1})=arg max_{ω,γ}T(ω,γ|ω^{t},γ^{t}). Eqn. (15)

Combining equations (9), (11), and (15) results in:

$${γ}^{q , t + 1} = \frac{{\sum }_{{y}^{q}} p ( {y}^{q} ) {\sum }_{i} I ( {y}_{i}^{q} \neq {\tilde{y}}_{i}^{q} )}{{n}_{q}} . \qquad Eqn . ( 16 )$$

In an implementation, T(ω, γ|ω^{t}, γ^{t}) is concave with regards to ω. In such an implementation, a gradient assent approach may be used to update the parameter ω.

In various embodiments, when the E step and M step iterations converge, estimates of parameters ω and y^{q} are obtained. The parameter γ^{q} can indicate the level of noise for the training query q, and the parameter ω can be used to perform ranking on new queries.

### Example Inference Technique

With one or more parameters of the graphical model 200 determined, objects 106 resulting from a new query may be ranked for relevance to the query. Given a new query, the actual relevance label y is inferred for its objects by maximizing P(y|x; ω). The actual label may be denoted as y*=argmaxP(y|x; ω). Then, the objects 106 are sorted according to their actual labels. In some embodiments, there may be multiple actual labels y*, where one or more of the actual labels y* can maximize the probability P(y|x; ω). In such cases, S* can be used to denote the set of actual relevance labels. This may be expressed as:

P(y|x;ω)>P(z|x;ω), ∀y∈S*, z∉S*. Eqn. (17)

In one embodiment, the inference process discussed above includes sorting the objects 106 in descending order of their scores ω^{T}x. This produces a ranked list of the objects 106 that is consistent with the set of actual relevance labels S*. This result is described by the theorem: Suppose π* is the permutation according to the descending order of ω^{T}x, then π* is consistent with S*.

For the purposes of this application, the definition of consistency as it applies to the above theorem is given as: Suppose that π is a permutation, π(i) denotes the position of the i-th object, S={y|y∈{0, 1, . . . , k−1}ⁿ} is a set of labels. Then π is consistent with S if

π(i)<π(j), ∀yᵢ>yⱼ, ∀y∈S Eqn. (18)

where π(i)<π(j) means the i-th object is ranked before the j-th document.

### Illustrative Processes

FIG. 3 illustrates an example methodology 300 for automatically determining a relevance of an object (e.g., a document, a media file, etc), according to an example embodiment. While the exemplary methods are illustrated and described herein as a series of blocks representative of various events and/or acts, the subject matter disclosed is not limited by the illustrated ordering of such blocks. For instance, some acts or events may occur in different orders and/or concurrently with other acts or events, apart from the ordering illustrated herein. In addition, not all illustrated blocks, events or acts, may be required to implement a methodology in accordance with an embodiment. Moreover, it will be appreciated that the exemplary methods and other methods according to the disclosure may be implemented in association with the methods illustrated and described herein, as well as in association with other systems and apparatus not illustrated or described.

At block 302, a system or device receives a set of training data, which includes one or more objects. In one example, the system or device may be configured as system 102 and the one or more objects may be configured as objects 106A-106N, as seen in FIG. 1. In another example, the object is a document in response to a query, such as a search query performed on a web search engine. Additionally, the training data may include a set of queries associated to the documents. In alternate embodiments, the object may be a media file, a data file, a text file, or the like.

At block 304, a modeling parameter for a graphical model (such as graphical model 200, for example) may be learned. In various embodiments, one or more modeling parameters are learned for the graphical model. Modeling parameters may include feature vectors of the objects (such as features x), weights of features of the objects (such as weights ω), noise parameters (such as noise parameter γ), or other parameters. For example, in one implementation, a modeling parameter represents a degree of noise in a proposed relevance of a document, where the modeling parameter is dependent on a query associated to the document. In alternate embodiments, some modeling parameters may be observable, and others may be hidden or initially hidden.

In one example, the method may include learning hidden or initially hidden modeling parameters for the graphical model by maximizing a log likelihood of the set of training data. The maximizing may include iterating an expectation maximization (EM) technique on the set of training data until the iterations converge. For instance, the EM technique may include iteratively performing operations of: estimating an expected value of the log likelihood of the training data with respect to a probability of the relevance of the document, given feature vectors of the document, a proposed relevance of the document, and an estimate of the modeling parameter; and selecting a modeling parameter that maximizes the expected value of the log likelihood. When the iterations converge, the resulting modeling parameter can be used in the graphical model.

In another example, the method may include updating one or more of the modeling parameters using a gradient assent technique. As shown in Eqn. (7), the log likelihood log L(ω,γ) is maximized. To use an example gradient assent technique, first compute the gradients of parameters:

$${{Δ {ω}_{t} = \frac{\partial log L ( ω , γ )}{\partial ω} \vert}_{ω = {w}_{t}} , \\ Δ {γ}_{t} = \frac{\partial log L ( ω , γ )}{\partial γ} \vert}_{γ = {γ}_{t}} .$$

First randomly initialize the parameters. Supposing the parameters are ω₀ and γ₀, then, iteratively update the parameters with an example algorithm as follows:

Fort = 0, 1, 2

ωₜ₊₁ = ωₜ + η * Δωₜ
γₜ₊₁ = γₜ + η * Δγₜ

Stop the iteration if the log likelihood logL(ω,γ) converges.

End for.

At block 306, noise in the training data is modeled with the graphical model. In one embodiment, the method includes using the modeling parameter(s) (e.g., features, weights, etc.) from block 304 to model the noise in the training data.

At block 308, a ranking function models the training data using the graphical model. In one embodiment, the model for the noise in the training data is separate and independent from the model of the ranking function for the training data. In an alternate embodiment, the models for the noise and the ranking function are integrated into the same graphical model.

In various embodiments, the graphical model may be configured to capture (1) a conditional dependency of an actual label of the document on the features of the document, and (2) a conditional dependency of an observed label of the document on the actual label of the document. For example, the graphical model is configured to distinguish the actual label of the document from the observed label of the document, where the graphical model is configured to model noise based on the query.

At block 310, a relevance of the object is determined. In the example of FIG. 1, the relevance 104 is based on the graphical model. In some embodiments, this analysis may include probabilistic techniques. The relevance of the document may be inferred by maximizing a probability of the relevance of the document, given a feature vector of the document and a weight of the feature vector. In an embodiment, the probability of the relevance of the document given the feature vector is based on a pairwise preference between the document and another document. In alternate embodiments, the relevance of the object is determined using statistical analysis techniques, machine learning techniques, artificial intelligence techniques, or the like.

In one embodiment, the method includes receiving a new relevance query, for example, from a user. The query may include a search query, for instance. In an implementation, the relevance of the object(s) returned from the query is determined based on the graphical model and the query.

In one embodiment, the method may include extracting features from the objects that are the result of a query to improve the relevance determination. For example, the extracted features may include the number of times a term or phrase appears within a document, the number of visits or “hits” a document accumulates within a time frame, the frequency that the document (or file, etc.) is updated, and the like.

At block 312, the determined relevance label (such as actual label y) may be associated to the object and output to one or more users. In alternate embodiments, the output may be in various electronic or hard-copy forms. For example, in one embodiment, the output is a searchable, annotated database that includes relevance ranking of the objects for ease of browsing, searching, and the like.

### CONCLUSION

Although implementations have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations. For example, the methodological acts need not be performed in the order or combinations described herein, and may be performed in any combination of one or more acts.

1. A system for determining a relevance of an object, the system comprising:
a processor;
memory coupled to the processor;
a modeling component stored in the memory and operable on the processor to:
adjust a graphical model based in part on a ranking function, the graphical model representing a relationship between an actual label and one or more features of the object; and
refine the graphical model based in part on noise in training data, the graphical model further representing a relationship between the actual label and an observed label of the object;
an analysis component stored in the memory and operable on the processor to determine the relevance of the object based on the graphical model; and
an output component stored in the memory and operable on the processor to output the relevance of the object.

2. The system of claim 1, wherein the modeling component is configured to map each of the one or more features of the object to a score using a weight parameter of the one or more features, and
wherein the analysis component is configured to determine whether the score is consistent with the actual label of the object.

3. The system of claim 2, wherein the analysis component is configured to measure a consistency of the score to the actual label based on a pairwise comparison of the object to another object.

4. The system of claim 1, wherein the graphical model describes a joint probability distribution of the actual label and the observed label, given the one or more features of the object.

5. The system of claim 4, wherein the joint probability distribution includes a conditional probability of the actual label given the one or more features of the object, considering a weight parameter of the one or more features of the object.

6. The system of claim 5, wherein the conditional probability of the actual label is represented by the equation:
$$P ( y \vert x ; ω ) = \frac{exp \{ {\sum }_{i} {\sum }_{j} {ω}^{T} ( {x}_{i} - {x}_{j} ) I ( {y}_{i} > {y}_{j} ) \}}{Z ( x )}$$
wherein y represents the actual label, x represents the one or more features of the object, ω represents the weight parameter of the one or more features of the object, T represents an expectation function, I(•) is an indicator function, and Z(x) equals Σ_{y} exp{ΣᵢΣⱼω^{T}(xᵢ−xⱼ)I(iᵢ>yⱼ)}.

7. The system of claim 4, wherein the output component is configured to output the relevance of the object in response to a query, and
wherein the joint probability distribution includes a conditional dependency represented by a query-dependent multinomial distribution, wherein the noise in the training data is dependent on the query.

8. The system of claim 1, wherein the analysis component is configured to associate the object with at least two random variables to determine the relevance of the object: a hidden variable representing the actual label and an observable variable representing the observed label.

9. The system of claim 1, wherein the output component is configured to rank the relevance of the object with respect to another object, and to output the relevance of the object and the relevance of the other object in an arrangement according to their respective rankings.

10. One or more computer readable storage media comprising computer executable instructions that, when executed by a computer processor, direct the computer processor to perform operations including:
learning at least two modeling parameters for a graphical model by maximizing a log likelihood of a set of training data;
modeling noise in the set of training data with the graphical model based in part on the at least two modeling parameters;
modeling a ranking function for the training data with the graphical model;
receiving a relevance query from a user regarding a document;
determining a ranked relevance of the document based on the graphical model and the query; and
outputting the ranked relevance of the document to the user.

11. The one or more computer readable storage media of claim 10, wherein the maximizing a log likelihood of the set of training data includes iterating an expectation maximization (EM) technique on the set of training data until the iterations converge.

12. The one or more computer readable storage media of claim 10, wherein the graphical model is configured to capture (1) a conditional dependency of an actual label of the document on the features of the document, and (2) a conditional dependency of an observed label of the document on the actual label of the document.

13. The one or more computer readable storage media of claim 12, wherein the graphical model is configured to distinguish the actual label of the document from the observed label of the document, the graphical model being configured to model noise based on the query.

14. A computer implemented method of determining a relevance of a document, the method comprising:
receiving a set of training data for a machine learning technique;
learning a modeling parameter for a graphical model by maximizing a log likelihood of the training data;
modeling noise in the training data with the graphical model based in part on the modeling parameter;
modeling a ranking function for the training data with the graphical model;
determining a relevance of the document based on the graphical model; and
outputting the relevance of the document.

15. The method of claim 14, wherein the training data comprises a set of queries, each of the queries being associated to a set of documents.

16. The method of claim 14, wherein the modeling parameter represents a weight of a feature of the document.

17. The method of claim 14, wherein the modeling parameter represents a degree of noise in a proposed relevance of a document, the modeling parameter being dependent on a query associated to the document.

18. The method of claim 14, wherein the maximizing comprises iteratively performing operations of:
estimating an expected value of the log likelihood of the training data with respect to a probability of the relevance of the document, given feature vectors of the document, a proposed relevance of the document, and an estimate of the modeling parameter; and
selecting a modeling parameter that maximizes the expected value of the log likelihood.

19. The method of claim 14, further comprising updating the modeling parameter using a gradient assent technique.

20. The method of claim 14, further comprising inferring a relevance of the document by maximizing a probability of the relevance of the document, given a feature vector of the document and a weight of the feature vector.

21. The method of claim 20, wherein the probability of the relevance of the document given the feature vector is based on a pairwise preference between the document and another document.
